(19) United States
(12) Patent Application Publication
(10) Pub. No.: US 2025/0038202 A1
(43) Pub. Date: Jan. 30, 2025

(54) CATHODE ACTIVE MATERIAL FOR SECONDARY BATTERY AND METHOD OF PRODUCING THE SAME

(71) Applicant: NICHIA CORPORATION, Anan-shi (JP)

(72) Inventors: Shigenobu NODA, Tokushima-shi (JP); Shunsuke SAWADA, Anan-shi (JP); Takashi ENOMOTO, Tokushima-shi (JP); Satoshi MATSUSHITA, Tokushima-shi (JP); Hideyuki KIRIE, Anan-shi (JP); Misaki KAWAI, Anan-shi (JP); Kento ISAI, Anan-shi (JP); Kenichi KOBAYASHI, Tokushima-shi (JP)

(73) Assignee: NICHIA CORPORATION, Anan-shi (JP)

(21) Appl. No.: 18/784,821

(22) Filed: Jul. 25, 2024

(30) Foreign Application Priority Data
Jul. 27, 2023 (JP) 2023-122588
Jul. 24, 2024 (JP) 2024-118607

(51) Int. Cl. H01M 4/58; C01B 25/45; H01M 4/02

(52) U.S. Cl. CPC H01M 4/5825; C01B 25/45; C01P 2006/10; C01P 2006/12; C01P 2006/22; C01P 2006/40; H01M 2004/028

(57) ABSTRACT

A method of producing a cathode active material for a secondary battery is provided. The method includes preparing a mixture comprising a lithium source, a phosphate source, an iron source, a carbon source, a boron source comprising an oxo acid of boron, and a liquid medium; granulating the mixture to obtain a precursor; and heat-treating the precursor to obtain a lithium transition metal compound having an olivine structure, wherein in the mixture, a total molar amount of boron atoms contained in the boron source is more than 0% and less than 3% with respect to a total molar amount of iron atoms contained in the iron source as 100%.

### CROSS-REFERENCE TO RELATED APPLICATIONS

This application claims priority to Japanese Patent Application No. 2023-122588, filed on Jul. 27, 2023 and Japanese Patent Application No. 2024-118607, filed on Jul. 24, 2024, the disclosures of which are hereby incorporated by reference in their entirety.

### BACKGROUND

### Field of the Invention

The present disclosure relates to a cathode active material for a secondary battery and a method of producing the cathode active material.

### Description of the Related Art

Lithium transition metal compounds having olivine structures are known as cathode active materials that can be used in lithium ion secondary batteries. For example, Japanese Translation of PCT International Application Publication No. 2007-502249 proposes a lithium insertion compound that has an olivine structure and is doped with boron.

### SUMMARY

Examples of conceivable techniques to obtain high output characteristics in secondary batteries include a technique to enlarge the specific surface area of a cathode active material. However, production of a cathode using a cathode active material having a large specific surface area has possibly result in the deterioration of productivity. An aspect of the present disclosure is directed at providing a cathode active material for a secondary battery, which can reduce the deterioration of productivity in production of a cathode, and at providing a method of producing the cathode active material.

A first aspect is a method of producing a cathode active material for a secondary battery, the method including: providing a mixture comprising a lithium source, a phosphate source, an iron source, a carbon source, a boron source containing an oxo acid of boron, and a liquid medium; granulating the mixture to obtain a precursor; and heat-treating the precursor to obtain a lithium transition metal compound having an olivine structure. In the mixture, a total molar amount of boron atoms contained in the boron source is more than 0% and less than 3% with respect to a total molar amount of iron atoms contained in the iron source as 100%.

A second aspect is a cathode active material for a secondary battery, including a lithium transition metal compound having an olivine structure, and having a boron content that is more than 0 ppm and less than 1900 ppm, and a specific surface area that is 15 m²/g or more.

According to an aspect of the present disclosure, a cathode active material for a secondary battery, which can reduce the deterioration of productivity in production of a cathode, and a method of producing the cathode active material may be provided.

### DETAILED DESCRIPTION

The term “step” as used herein encompasses not only an independent step but also a step not clearly distinguishable from another step as long as the intended purpose of the step is achieved. If multiple substances correspond to a component in a composition, the content of the component in the composition means the total amount of the multiple substances present in the composition unless otherwise specified. Further, upper limit and lower limit values that are described for a numerical range in the present specification can be arbitrarily selected and combined. Embodiments of the present invention will now be described in detail. The embodiments described below are exemplifications of a cathode active material for a secondary battery and a method of producing the same for embodying the technical ideas of the present invention, and the present invention is not limited to the cathode active material for a secondary battery and the method of producing the same described below.

### Method of Producing Cathode Active Material for Secondary Battery

A method of producing a cathode active material for a secondary battery includes: a providing step of providing a mixture comprising a lithium source, a phosphate source, an iron source, a carbon source, a boron source containing an oxo acid of boron, and a liquid medium; a granulation step of granulating the provided mixture to obtain a precursor; and a heat treatment step of heat-treating the provided precursor to obtain a lithium transition metal compound having an olivine structure. In accordance with the method of producing a cathode active material for a secondary battery, a cathode active material for a secondary battery, reducing the deterioration of productivity in production of a cathode, may be efficiently produced.

A lithium transition metal compound obtained by heat-treating a mixture obtained by primary addition of a boron source may reduce the viscosity of a cathode material paste used when a cathode for a secondary battery is produced, while having a sufficient specific surface area. The reduced viscosity of the cathode material paste enables a cathode having favorable output characteristics to be produced with favorable productivity. Here, the primary addition of the boron source means that the boron source is added to the raw mixture comprising a lithium transition metal compound having an olivine structure to synthesize the lithium transition metal compound in the presence of the boron source. Addition of a boron source to the synthesized lithium transition metal compound to perform heat treatment and the like is referred to as secondary addition.

In the providing step, the mixture including the carbon source, the boron source, and the liquid medium as well as the lithium, phosphate, and iron sources included in the lithium transition metal compound is provided. The mixture may be provided by mixing the lithium source, the phosphate source, the iron source, the carbon source, the boron source, and the liquid medium. A mixing method may be selected from commonly used mixing methods, as appropriate. The mixture may be a pulverization-treated product including the lithium source, the phosphate source, the iron source, the carbon source, the boron source, and the liquid medium, or may be slurry with flowability.

The lithium source included in the mixture may contain a lithium compound. Examples of the lithium compound may include lithium phosphate, lithium carbonate, and lithium hydroxide. The lithium source may preferably contain at least lithium phosphate (for example, Li₃PO₄). The content of the lithium source contained in the mixture may be more than 0.9 and less than 1.1, and preferably 0.95 or more and 1.05 or less, for example, in terms of the ratio of the molar number of lithium contained in the lithium source to the total molar number of phosphorus contained in the mixture. In terms of the ratio of the molar number of lithium contained in the lithium source to the molar number of iron atoms contained in the iron source, the content of the lithium source contained in the mixture may be, for example, 1 or more and 1.1 or less, or may be preferably 1.01 or more, or 1.02 or more, and may be preferably 1.07 or less, or 1.05 or less.

The iron source included in the mixture may contain an iron compound, iron, and/or the like. Examples of such iron compounds include phosphates, nitrates, carbonates, and oxides, and at least a phosphate (for example, Fe₃(PO₄)₂) may be contained as the iron compound. In a case in which iron contained in the iron compound is divalent iron, the carbonization of the carbon source is prone to occur prior to the growth of the crystals of the lithium transition metal compound, whereby the specific surface area of the obtained cathode material tends to become larger, and a discharge capacity under high load conditions tends to become larger. The content of the iron source contained in the mixture may be more than 0.8 and 1.8 or less, and preferably 0.9 or more and 1.6 or less, for example, in terms of the ratio of the molar number of iron atoms to the total molar number of phosphorus contained in the mixture.

The phosphate source included in the mixture may contain a phosphate compound. Examples of such phosphate compounds may include phosphate compounds containing lithium, phosphate compounds containing iron, and phosphate compounds containing neither lithium nor iron. Examples of the phosphate compounds containing lithium include lithium phosphate. Such a phosphate compound containing lithium may serve as the lithium source in the mixture. Examples of the phosphate compounds containing iron include iron phosphate. Such a phosphate compound containing iron may serve as the iron source in the mixture. Examples of the phosphate compounds containing neither lithium nor iron may include ammonium phosphate and phosphoric acid. Ammonium dihydrogen phosphate may be used as ammonium phosphate. The content of the phosphate compound containing neither lithium nor iron, contained in the mixture, may be more than 0% by mol and 3% by mol or less, and preferably 0.5% by mol or more and 2.5% by mol or less, 1% by mol or more and 2% by mol or less, or 1.5% by mol or more and 1.8% by mol or less, for example, in terms of the ratio of the molar number thereof to the total molar amount of iron atoms contained in the mixture. A cathode material further improved in crystallinity tends to be easily obtained when the content of the phosphate compound containing neither lithium nor iron, contained in the mixture, falls within the range described above.

The carbon source included in the mixture may be carbon, or may be a carbon compound that can generate carbon by heat treatment. Examples of the carbon compound contained in the carbon source include dextrin, sucrose, and starch, and the carbon source may contain at least one selected from the group consisting thereof. The carbon source preferably contains dextrin from the viewpoint of a carbonization rate. The content of the carbon source contained in the mixture may be, for example, 15% by mass or more and 30% by mass or less, preferably 16% by mass or more, 17% by mass or more, or 18% by mass or more, and preferably 25% by mass or less, or 20% by mass or less with respect to the total mass of iron atoms contained in the mixture.

The boron source included in the mixture may contain an oxo acid of boron. The boron source may contain a boron oxide that can generate an oxo acid of boron, and may be an oxygen-containing boron compound containing neither a metal element nor phosphorus. Examples of the boron source include oxygen-containing boron compounds such as: oxo acids of boron, such as orthoboric acid (H₃BO₃), metaboric acid ((HBO₂)ₙ), perboric acid (HBO₃), hypoboric acid (H₄B₂O₄), boronic acid (H₃BO₂), and borinic acid (H₃BO); and boron oxides such as diboron trioxide (B₂O₃), diboron dioxide (B₂O₂), tetraboron trioxide (B₄03), and tetraboron pentoxide (B₄O₅). The boron source may contain at least an oxo acid of boron, and may contain at least orthoboric acid. The total molar amount of boron atoms contained in the boron source contained in the mixture may be more than 0% by mol and less than 3% by mol, preferably 0.1% by mol or more and 2.5% by mol or less, 0.2% by mol or more and 1.8% by mol or less, 0.4% by mol or more and 1.6% by mol or less, or 0.5% by mol or more and 1.5% by mol or less, for example, with respect to the total molar amount of iron atoms contained in the mixture. In an embodiment of the mixture, the total molar amount of boron atoms may be 0.1% by mol or more, 0.3% by mol or more, 0.5% by mol or more, 0.6% by mol or more, 0.8% by mol or more, 0.9% by mol or more, 1.0% by mol or more, or 1.4% by mol or more, and may be 2.2% by mol or less, 1.8% by mol or less, 1.6% by mol or less, 1.4% by mol or less, 1.2% by mol or less, or 0.8% by mol or less, with respect to the total molar amount of iron atoms. Both of the maintenance of rate characteristics and improvement in paste viscosity tend to be easily achieved when the content of the boron source contained in the mixture falls within the range described above.

The liquid medium may contain at least water, and may further contain a water-soluble organic solvent such as alcohol or acetone as well as water. The mixture may be composed as slurry with flowability. The content of the iron source contained in the mixture may be, for example, 3% by mass or more and 15% by mass or less, and preferably 4% by mass or more and 10% by mass or less in terms of the content of iron atoms.

The mixture may further contain a first metal source containing a first metal element including at least one selected from the group consisting of manganese (Mn), cobalt (Co), nickel (Ni), and copper (Cu), as necessary. The first metal source may further contain a metal compound containing the first metal element, the single first metal element, or the like. Examples of such metal compounds include phosphates, nitrates, carbonates, and oxides. The metal compound may contain at least a phosphate. The content of the first metal source contained in the mixture may be 0 or more and less than 1, preferably 0.8 or less, 0.7 or less, 0.4 or less, or 0.2 or less, for example, in terms of the ratio of the molar number of the first metal element to the total molar number of iron contained in the mixture and the first metal element. The first metal atom may preferably include at least one selected from the group consisting of manganese (Mn), cobalt (Co), and nickel (Ni).

The mixture may further contain a second metal source containing a second metal element including at least one selected from the group consisting of Group 2 elements, Group 3 elements, Group 4 elements, Group 6 elements, Group 12 elements, Group 13 elements, Group 14 elements, and lanthanoids, as necessary. The second metal source may contain a metal compound containing the second metal element, the single second metal element, or the like. Examples of such metal compounds include phosphates, oxides, carbonates, and halides. The metal compound may include at least a phosphate.

The second metal element may preferably include at least one selected from the group consisting of magnesium (Mg), calcium (Ca), strontium (Sr), barium (Ba), scandium (Sc), yttrium (Y), titanium (Ti), zirconium (Zr), chromium (Cr), molybdenum (Mo), zinc (Zn), aluminum (Al), gallium (Ga), indium (In), silicon (Si), germanium (Ge), and cerium (Ce). The second metal element may preferably include at least one selected from the group consisting of molybdenum (Mo), magnesium (Mg), titanium (Ti), zirconium (Zr), chromium (Cr), aluminum (Al), and cerium (Ce).

The content of the second metal source contained in the mixture may be 0 or more and less than 1, and preferably 0 or more and 0.5 or less, 0 or more and 0.3 or less, 0 or more and 0.1 or less, or 0 or more and 0.03 or less, for example, in terms of the molar number of second metal atoms to the total molar number of phosphorus contained in the mixture. In addition, the ratio of the total molar number of iron atoms and the second metal atoms to the total molar number of phosphorus contained in the mixture may be more than 0.9 and less than 1.1, and preferably 0.95 or more and 1.05 or less.

The mixture may contain a pH adjuster, as necessary. Examples of the pH adjuster may include citric acid, sulfuric acid, and ammonium carbonate. The content of the pH adjuster contained in the mixture may be adjusted as appropriate so that the mixture exhibits a desired pH.

The mixture can be prepared by pulverization treatment of a composition containing the lithium source, the iron source, the phosphate source, the liquid medium, and the like. The mixture may be prepared by, for example, the following preparation methods (1) to (4).
(1) The first preparation method may include: performing pulverization treatment of a first preliminary mixture containing a lithium source, a phosphate source, an iron source, and a liquid medium to obtain a first pulverization-treated product; and mixing the first pulverization-treated product, a carbon source, and a boron source to obtain a mixture.
(2) The second preparation method may include: performing pulverization treatment of a second preliminary mixture containing a lithium source, a phosphate source, an iron source, a carbon source, and a liquid medium to obtain a second pulverization-treated product; and mixing the second pulverization-treated product and a boron source to obtain a mixture.
(3) The third preparation method may include: performing pulverization treatment of a third preliminary mixture containing a lithium source, a phosphate source, an iron source, a boron source, and a liquid medium to obtain a third pulverization-treated product; and mixing the third pulverization-treated product and a carbon source to obtain a mixture.
(4) The fourth preparation method may include performing pulverization treatment of a fourth preliminary mixture containing a lithium source, a phosphate source, an iron source, a carbon source, a boron source, and a liquid medium to obtain a mixture as a fourth pulverization-treated product.

The pulverization treatment may be performed using, for example, a ball mill, a vibration mill, a roll mill, a grinding machine, or the like. The pulverization-treated product obtained by the pulverization treatment may be slurry with flowability. Time for the pulverization treatment may be, for example, 10 hours or more, preferably 20 hours or more, or 60 hours or less.

The pulverization treatment may be performed so that the volume mean particle diameter of the pulverization-treated product is 0.05 μm or more and 1 μm or less, and preferably 0.1 μm or more and 0.5 μm or less. The solid content concentration of the pulverization-treated product may be, for example, 5% by mass or more and 50% by mass or less, and preferably 10% by mass or more and 30% by mass or less. The volume mean particle diameter of the pulverization-treated product is measured using a laser diffraction type particle size distribution measurement apparatus.

A method of mixing the pulverization-treated product with the carbon source or the boron source may be selected from commonly used mixing methods, as appropriate. The method of mixing the pulverization-treated product with the carbon source or the boron source may include pulverization treatment. Time for the pulverization treatment may be, for example, 1 minute or more and 60 hours or less.

The volume mean particle diameter of the mixture provided in the providing step may be, for example, 0.05 μm or more and 1 μm or less, and preferably 0.1 μm or more and 0.5 μm or less. The solid content concentration of the mixture may be, for example, 5% by mass or more and 50% by mass or less, and preferably 10% by mass or more and 30% by mass or less.

In the granulation step, at least a part of the liquid medium contained in the provided mixture is removed to obtain a precursor as granulated dry matter. The volume mean particle diameter D₅₀ of the precursor may be, for example, 1 μm or more and 20 μm or less, preferably 5 μm or more, or 7 μm or more, and preferably 16 μm or less. Examples of a method of drying the mixture include spray drying and fluidized bed drying. Spray drying is preferred as the method. The volume mean particle diameter of the precursor is measured using a laser diffraction type particle size distribution measurement apparatus.

When the granulation step is carried out by the spray drying, for example, the ratio of the amount of supplied gas to the amount of supplied mixture may be, for example, 500 or more and 4000 or less, and preferably 800 or more and 2000 or less in terms of a volume ratio as a specific condition for the spray drying. A drying temperature may be, for example, 100° C. or more and 170° C. or less, and preferably 100° C. or more and 120° C. or less.

In the heat treatment step, the provided precursor is heat-treated to obtain a heat-treated product containing a lithium transition metal compound having an olivine structure. The temperature of the heat treatment may fall within a range of, for example, 500° C. or more and 700° C. or less, and preferably 600° C. or more and 650° C. or less. The heat treatment step may include increasing the temperature to a predetermined heat treatment temperature, keeping the heat treatment temperature, and decreasing the temperature from the heat treatment temperature. A temperature-raising rate up to the heat treatment temperature may be 2.5° C./min or more and 5° C./min or less, preferably 3.0° C./min or more, or 3.3° C./min or more, and preferably 4.5° C./min or less, or 4.2° C./min or less, for example, in terms of a temperature-increasing rate from room temperature. Heat treatment time for keeping the heat treatment temperature may be, for example, 0.1 hours or more and 15 hours or less, preferably 0.2 hours or more, 0.3 hours or more, or 0.4 hours or more, and preferably 12 hours or less, 8 hours or less, or 5 hours or less. A temperature-decreasing rate from the heat treatment temperature may be, for example, 1° C./min or more and 600° C./min or less in terms of a temperature-decreasing rate up to room temperature.

Atmosphere in the heat treatment step may be, for example, inert gas atmosphere including a noble gas such as nitrogen or argon. In the inert gas atmosphere, for example, the content of inert gas may be 90% by volume or more, preferably 95% by volume or more, or 98% by volume or more. The heat treatment may be performed under the circulation of inert gas.

A pressure in the atmosphere in the heat treatment step may be atmospheric pressure, or may be under a pressurization or depressurization condition. As a pressurization condition, a gauge pressure may be, for example, more than 0 MPa and 0.1 MPa or less, preferably more than 0 MPa and 0.05 MPa or less. As a depressurization condition, a gauge pressure may be, for example, −0.1 MPa or more and less than 0 MPa, and preferably −0.05 MPa or more and less than 0 MPa.

The heat treatment of the precursor can be performed by using, for example, a box-type atmosphere furnace, a tubular furnace, a carbon rotary kiln, or the like. It is possible to perform the heat treatment of the precursor filled into, for example, a crucible, a boat, or the like with an aluminum oxide material. In addition to the aluminum oxide material, a carbon material such as graphite, a boron nitride (BN) material, a molybdenum material, or the like can be used.

The heat-treated product obtained in the heat treatment step may be subjected to treatment such as pulverization, dispersion, washing, filtration, or classification treatment, and may be subjected to at least pulverization treatment and classification treatment.

### Cathode Active Material for Secondary Battery

A cathode active material for a secondary battery (hereinafter also simply referred to as “cathode active material”) may include a lithium transition metal compound having an olivine structure. The content of boron in the composition of the cathode active material may be more than 0 ppm and less than 1900 ppm. The cathode active material may have a specific surface area of 15 m²/g or more. The cathode active material may be produced by the above-described method of producing a cathode active material for a secondary battery.

The viscosity of a cathode material paste containing the cathode active material can be reduced when the composition of the cathode active material includes boron and the content of boron in the composition is more than 0 ppm and less than 1900 ppm. This is considered to be because, for example, the presence of a boron compound between primary particles included in the cathode active material including secondary particles enables the inhibition of the absorption of a solvent such as NMP in the secondary particles of the cathode active material.

The viscosity of the cathode material paste containing the cathode active material is measured, for example, in a manner described below.

### (1) Preparation of Paste for Measurement

A carbon material as a conductive agent, polyvinylidene fluoride (PVDF) as a binder, and N-methyl-2-pyrrolidone (NMP) as a solvent are mixed at a mass ratio of 1:1:14.85 to prepare a carbon mixture. The carbon mixture and the cathode active material are mixed at a mass ratio of 1.00:1.08 for 5 minutes by a stirring machine to obtain a first mixture. NMP is added so that a solid content concentration is 45.5%, and further mixed for 10 minutes by a stirring machine, to obtain a paste for measurement.

(2) Conditions under Which Paste Viscosity Is Measured

The viscosity of the paste for measurement is measured twice at 25° C. by using an E-type viscometer device, and the arithmetic mean value of the two measured values thereof is regarded as the paste viscosity of the cathode material paste.

CABOT LITX-200 (CABOT and LITX are registered trademarks) is used as the carbon material used in the preparation of the paste for measurement. W #9700 (manufactured by KUREHA CORPORATION) is used as PVDF. The paste viscosity of the paste for measurement may be, for example, 2000 mPa·s or less, and preferably 1700 mPa·s or less. The paste viscosity of the paste for measurement may be 1400 mPa·s or more.

The cathode active material contains boron. The content of boron in the cathode active material may be preferably 100 ppm or more, 200 ppm or more, 300 ppm or more, 400 ppm or more, 580 ppm or more, or 800 ppm or more, and preferably 1500 ppm or less, 1200 ppm or less, 1000 ppm or less, 800 ppm or less, 700 ppm or less, or 400 ppm or less. When the boron content is within the range described above, the paste viscosity tends to be able to be further reduced.

The cathode active material may include, for example, secondary particles formed by aggregation of a plurality of primary particles including a carbon material adhering to the surfaces. Boron included in cathode active material may be considered to be included in, for example, the carbon material adhering to the primary particles. In other words, the cathode active material may include the secondary particles formed by the aggregation of the plurality of primary particles including the carbon material containing boron adhering to the surfaces. The primary particles may include a lithium transition metal compound having an olivine structure, and the primary particles may consist substantially of a lithium transition metal compound having an olivine structure. The term “substantially” as used herein means that a component other than the lithium transition metal compound having an olivine structure, inevitably included in the primary particles, is not excluded, and the content of the component other than the lithium transition metal compound having an olivine structure in the primary particles is, for example, 1% by mass or less, and preferably 0.5% by mass or less.

The carbon material may adhere to the surfaces of the primary particles included in the cathode active material. The adhesion of the carbon material may be, for example, physical adsorption caused by Van der Waals force or the like. The adhering carbon material may be granulous or membranous, preferably membranous. The amount of the carbon material adhering to the primary particles may be evaluated as the content of carbon included in the cathode active material. The content of carbon in the cathode active material may be, for example, more than 0.5% by mass and 1.8% by mass or less, and preferably 1.6% by mass or less, 1.5% by mass or less, or 1.4% by mass or less, with respect to, for example, the total mass of the cathode active material. The content of carbon in the cathode active material may be 0.8% by mass or more, preferably 0.9% by mass or more, 1.0% by mass or more, or 1.1% by mass or more with respect to, for example, the total mass of the cathode active material. When the content of carbon in the cathode active material is within the range described above, load characteristics tend to be able to be enhanced while maintaining a high pellet density. The content of carbon in the cathode active material can be measured by, for example, a total organic carbon meter (TOC meter).

The lithium transition metal compound contained in the cathode active material may be a phosphate compound that has an olivine structure and includes a composition containing at least an iron atom, a lithium atom, and a phosphorus atom. The lithium transition metal compound may further contain a first metal atom including at least one selected from the group consisting of manganese (Mn), cobalt (Co), nickel (Ni), and copper (Cu), as necessary. The first metal atom may preferably include at least one from the group consisting of manganese (Mn), cobalt (Co), and nickel (Ni). The lithium transition metal compound may further contain a second metal atom including at least one selected from the group consisting of Group 2 elements, Group 3 elements, Group 4 elements, Group 6 elements, Group 12 elements, Group 13 elements, Group 14 elements, and lanthanoids, as necessary.

The second metal atom may preferably include at least one selected from the group consisting of magnesium (Mg), calcium (Ca), strontium (Sr), barium (Ba), scandium (Sc), yttrium (Y), titanium (Ti), zirconium (Zr), chromium (Cr), molybdenum (Mo), zinc (Zn), aluminum (Al), gallium (Ga), indium (In), silicon (Si), germanium (Ge), and cerium (Ce). The second metal atom may preferably include at least one selected from the group consisting of molybdenum (Mo), magnesium (Mg), titanium (Ti), zirconium (Zr), chromium (Cr), aluminum (Al), and cerium (Ce).

The lithium transition metal compound may include, for example, the following composition. The ratio of the molar number of lithium atoms to the molar number of phosphorus atoms may be more than 0.9 and less than 1.1, and preferably 0.95 or more and 1.05 or less. The ratio of the molar number of iron atoms to the molar number of the phosphorus atoms may be more than 0.8 and 1 or less, and preferably 0.9 or more and 1 or less. The ratio of the molar number of the first metal atoms to the molar number of the phosphorus atoms may be 0 or more and less than 1, and may be 0.8 or less, 0.7 or less, 0.4 or less, or 0.2 or less. The ratio of the total molar number of the iron atoms and the first metal atoms to the molar number of the phosphorus atoms may be more than 0.9 and less than 1.1, and preferably 0.95 or more and 1.05 or less.

The ratio of the molar number of the second metal atoms to the molar number of the phosphorus atoms may be 0 or more and less than 1, and preferably 0 or more and 0.5 or less, 0 or more and 0.3 or less, 0 or more and 0.1 or less, or 0 or more and 0.03 or less. The ratio of the total molar number of the iron atoms and the second metal atoms to the molar number of the phosphorus atoms may be more than 0.9 and less than 1.1, and preferably 0.95 or more and 1.05 or less.

The lithium transition metal compound may include, for example, a composition represented by the following formula (1).

Liₓ(Fe_{(1-y)}M¹_{y})_{(1-z)}M²_{z}(PO₄)_{w} (1)

In the formula, x, y, z, and w may satisfy 0.9<x<1.3, 0≤y<1, 0≤z<0.3, and 0.9≤w≤1.3. M¹ may include at least one metal element selected from the group consisting of Mn, Co, and Ni. M² may include at least one metal element selected from the group consisting of W, Mo, Mg, Zr, Ti, Al, Ce, and Cr.

In addition, x, y, z, and w may preferably satisfy at least any one of 0.95<x<1.1, 0≤y<0.8, 0≤y<0.7, 0≤y<0.4, 0≤y<0.2, 0≤z<0.1, 0≤z<0.03, 0.95≤w<1.1, 1.0≤w≤1.1, and 1.005≤w≤1.1.

The specific surface area of the cathode active material may be preferably 14 m²/g or more, 17 m²/g or more, or 18 m²/g or more. The specific surface area may be, for example, 45 m²/g or less, 30 m²/g or less, 24 m²/g or less, or 20 m²/g or less. When the specific surface area is within the range described above, an output characteristic (for example, rate characteristic) in a secondary battery tends to be further improved. The specific surface area of the cathode active material may be a specific surface area measured by a BET method, and is measured by a one-point method using nitrogen gas on the basis of a BET (Brunauer Emmett Teller) theory.

The oil absorption amount of the cathode active material for N-methyl-2-pyrrolidone may be, for example, 40 mL/100 g or less, or 30 mL/100 g or less, and preferably 29 mL/100 g or less, or 28 mL/100 g or less. The oil absorption amount for N-methyl-2-pyrrolidone may be, for example, 20 mL/100 g or more, or 26 mL/100 g or more. When the oil absorption amount of the cathode active material for N-methyl-2-pyrrolidone is within the range described above, the secondary particles can tend to be able to be densified to improve a pellet density. The oil absorption amount of the cathode material is measured according to a method defined in JIS K5101-13-1.

A cathode formed using the cathode active material is excellent in the packing property of a cathode active material layer included in the cathode. The packing property of the cathode active material layer can be evaluated based on the density of pellets that include the cathode active material and are formed under predetermined conditions. The cathode active material may have a pellet density of, for example, 2.00 g/cm³ or more, preferably 2.02 g/cm³ or more, 2.04 g/cm³ or more, 2.05 g/cm³ or more, 2.06 g/cm³ or more, or 2.08 g/cm³ or more in a case in which the cathode active material is compressed at a pressure of 3.5 MPa to form pellets. The pellet density may be, for example, 2.3 g/cm³ or less, or 2.2 g/cm³ or less.

The volume mean particle diameter D₅₀ of the cathode active material may be, for example, 1 μm or more and 20 μm or less, preferably 4 μm or more, 6 μm or more, 8 μm or more, or 9 μm or more. The volume mean particle diameter may be preferably 18 μm or less, 15 μm or less, 12 μm or less, or 11 μm or less. The volume mean particle diameter of the cathode active material is determined as a particle diameter corresponding to a volume accumulation of 50% from a smaller-diameter side in a cumulative particle size distribution based on a volume. The cumulative particle size distribution based on a volume is measured by, for example, a laser diffraction type particle size distribution measurement apparatus. When the volume mean particle diameter of the cathode active material is within the range described above, workability in the production tends to be improved.

### Cathode for Secondary Battery

The cathode for a secondary battery includes: a current collector; and a cathode active material layer that is placed on the current collector and includes the cathode active material described above. A secondary battery including such a cathode can achieve an excellent charge and discharge capacity. The cathode for a secondary battery may be, for example, a cathode for a lithium ion secondary battery.

The density of the cathode active material layer may be, for example, 1.6 g/cm³ or more and 2.8 g/cm³ or less, preferably 1.8 g/cm³ or more and 2.6 g/cm³ or less, 1.9 g/cm³ or more and 2.5 g/cm³ or less, 2.0 g/cm³ or more and 2.4 g/cm³ or less, or 2.05 g/cm³ or more and 2.3 g/cm³ or less. The density of the cathode active material layer is calculated by dividing the mass of the cathode active material layer by the volume of the cathode active material layer.

Examples of the material of the current collector include aluminum, nickel, and stainless steel. The cathode active material layer can be formed by applying, onto the current collector, an electrode composition obtained by mixing the cathode material, conductive agent, and binder described above, and the like with a solvent, and subjecting the electrode composition to drying treatment, pressurization treatment, and the like. Examples of the conductive agent include natural graphite, artificial graphite, and acetylene black. Examples of the binder include polyvinylidene fluoride, polytetrafluoroethylene, and polyamide acryl resin. Examples of the solvent include N-methyl-2-pyrrolidone (NMP).

### Secondary Battery

The secondary battery includes the above-described cathode for a secondary battery. The secondary battery may be, for example, a lithium ion secondary battery. The lithium ion secondary battery includes an anode for a lithium ion secondary battery, a nonaqueous electrolyte, a separator, and the like, as well as the cathode for a secondary battery. As the anode for a lithium ion secondary battery, the nonaqueous electrolyte, the separator, and the like in the lithium ion secondary battery, anodes for lithium ion secondary batteries, nonaqueous electrolytes, separators, and the like, for used in lithium ion secondary batteries, described in, for example, Japanese Patent Laid-Open No. 2002-075367, Japanese Patent Laid-Open No. 2011-146390, Japanese Patent Laid-Open No. 2006-12433 (the disclosures of which are incorporated by reference herein in their entirety), and the like, can be used as appropriate.

The present disclosure also further encompasses use of the cathode active material for a secondary battery in the production of the cathode for a secondary battery, and a cathode active material for a secondary battery, used in the production of the cathode for a secondary battery.

### EXAMPLES

The present invention is more specifically described below with reference to Examples. However, the present invention is not limited to Examples.

### Example 1

### Providing Step

In a ball mill container, 1662.0 g of slurry prepared by dispersing iron phosphate (Fe₃(PO₄)₂) in pure water so that the concentration of iron atoms was 7.22% by mass, 86.3 g of lithium phosphate (Li₃PO₄), 4.2 g of ammonium dihydrogen phosphate, 0.74 g of orthoboric acid (H₃BO₃), 6.0 g of citric acid, and 1092 g of pure water were put, subjected to pulverization treatment for 40 hours by using a zirconia ball, and mixed while refining the resultant to obtain a pulverization-treated product. To the obtained pulverization-treated product, 15% by mass of dextrin solution in an amount of 149.6 g was added. The resultant was subjected to further pulverization treatment for 3 hours to obtain a mixture.

The ratio of the molar number of lithium atoms contained in lithium phosphate to the molar number of iron atoms contained in the mixture was 1.03, and the rate of the molar number of ammonium dihydrogen phosphate to the molar number of iron atoms contained in the mixture was 1.70% by mol. The rate of the mass of dextrin to the mass of the iron atoms contained in the mixture was 18% by mass, and the rate of the mass of citric acid was 5.0% by mass.

### Granulation Step

The mixture subjected to the pulverization treatment was spray-dried to obtain a precursor having a mean particle diameter of 11 μm to 12 μm. Scanning electron microscope (SEM) observation revealed that the particle diameters of primary particles included in the precursor were several tens of nanometers.

### Heat Treatment Step

Into an aluminum crucible having a width of 120 mm and a height of 50 mm, 80 g of the obtained precursor was filled. The precursor was subjected to heat treatment at 650° C. for 9 hours under nitrogen gas atmosphere to obtain the cathode active material of Example 1 as a heat-treated product. In the heat treatment, nitrogen gas was allowed to flow at a flow rate of 40 L/min from the horizontal direction with respect to the vicinity of the upper side of the crucible.

The phase identification of the obtained cathode active material was performed using an X-ray diffractometer. As a result of analysis using a CuKα, ray (wavelength: λ=1.54 nm) as an X-ray, the composition thereof was confirmed to be an olivine-type lithium transition metal compound represented by LiFePO₄. Likewise, the compositions of cathode active materials in all the examples and comparative examples described below were confirmed to be an olivine-type lithium transition metal compound represented by LiFePO₄.

### Example 2

The cathode active material in Example 2 was produced by a method similar to that in Example 1 except that the amount of added orthoboric acid (H₃BO₃) was changed to 1.46 g in a providing step.

### Example 3

The cathode active material in Example 3 was produced by a method similar to that in Example 1 except that the amount of added orthoboric acid (H₃BO₃) was changed to 2.17 g in a providing step.

### Comparative Example 1

The cathode active material in Comparative Example 1 was produced by a method similar to that in Example 1 except that orthoboric acid (H₃BO₃) was not added in a providing step.

### Comparative Example 2

The cathode active material in Comparative Example 2 was produced by a method similar to that in Example 1 except that 1.16 g of boron phosphate (BPO₄) was added instead of orthoboric acid (H₃BO₃) in a providing step.

### Comparative Example 3

The cathode active material in Comparative Example 3 was produced by a method similar to that in Comparative Example 2 except that the amount of added boron phosphate (BPO₄) was changed to 2.32 g in a providing step.

### Comparative Example 4

The cathode active material in Comparative Example 4 was produced by a method similar to that in Comparative Example 2 except that the amount of added boron phosphate (BPO₄) was changed to 3.48 g in a providing step.

### Comparative Example 5

The cathode active material in Comparative Example 5 was produced by a method similar to that in Example 1 except that the amount of added orthoboric acid (H₃BO₃) was changed to 4.33 g in a providing step.

### Comparative Example 6

A providing step and a granulation step are carried out to obtain a precursor in a manner similar to that in Example 1 except that orthoboric acid (H₃BO₃) was not added in the providing step. Into an aluminum crucible having a width of 120 mm and a height of 50 mm, 80 g of the obtained precursor was filled. The precursor was subjected to heat treatment at 650° C. for 9 hours under nitrogen gas atmosphere to obtain a heat-treated product. Secondary addition of 0.36 g of orthoboric acid (H₃BO₃) to 60 g of the obtained heat-treated product was performed, and the resultant was mixed. Then, the mixture was heat-treated at 650° C. for 3 hours under nitrogen gas atmosphere to produce the cathode active material of Comparative Example 6. In the heat treatment, nitrogen gas was allowed to flow at a flow rate of 40 L/min from the horizontal direction with respect to the vicinity of the upper side of the crucible.

### Comparative Example 7

In a ball mill container, 45.0 g of iron phosphate (Fe₃(PO₄)₂) slurry in which the concentration of iron atoms was 39.2% by mass, 12.69 g of lithium phosphate (Li₃PO₄), 0.36 g of ammonium dihydrogen phosphate, and 4.59 g of dextrin were put, subjected to pulverization treatment for 4 hours, and mixed while refining the resultant to obtain the mixture.

The ratio of the molar number of lithium atoms contained in lithium phosphate to the molar number of iron atoms contained in the mixture was 1.03, and the rate of the molar number of ammonium dihydrogen phosphate to the molar number of iron atoms contained in the mixture was 1.00% by mol. The rate of the mass of dextrin to the mass of iron atoms contained in the mixture was 26% by mass.

Into an aluminum crucible having a width of 120 mm and a height of 50 mm 80 g of the mixture subjected to the pulverization treatment was filled, and subjected to heat treatment at 650° C. for 9 hours under nitrogen gas atmosphere to obtain the cathode active material of Comparative Example 7. In the heat treatment, nitrogen gas was allowed to flow at a flow rate of 40 L/min from the horizontal direction with respect to the vicinity of the upper side of the crucible.

### Evaluation of Physical Properties

The following measurement of each cathode active material containing the olivine-type lithium transition metal compound obtained as described above was performed. The results are set forth in Table 1.

### Mean Particle Diameter

The cumulative particle size distribution, based on a volume, of each cathode active material obtained as described above was measured using a laser diffraction type particle size distribution measurement apparatus (SALD-3100 manufactured by SHIMADZU CORPORATION), and the volume mean particle diameter D₅₀ of the cathode active material was determined as a particle diameter corresponding to an accumulation of 50% from a smaller-diameter side.

### Specific Surface Area

The BET specific surface area of each cathode active material obtained as described above was measured using a BET specific surface area measurement apparatus (Macsorb, manufactured by Mountech Co., Ltd.) by a gas absorption method (one-point method) using nitrogen gas.

### Crystallinity

The X-ray diffraction spectrum (tube current of 200 mA and tube voltage of 45 kV) of each cathode active material obtained as described above was measured by a CuKα ray, and a diffraction peak obtained at 2θ=around 32 degrees was subjected to fitting by a least square method using a Pseudo-Voigt function to calculate the values of θ and β. A crystallinity D was calculated based on the following equation (2) from the diffraction peak resulting from a space group Pnmb (031) plane determined by an X-ray diffraction method.

$$D = {K}^{′} λ / ( β cos θ ) \qquad ( 2 )$$

In the expression (3), D represents a crystallinity (Å), λ represents the wavelength of an X-ray source (1.54 Å in the case of CuKα), β represents an integration width (radian), and θ represents a diffraction angle (degree(s)). A value that was measured using sintering Si for adjusting an optical system (manufactured by Rigaku Denki Co., Ltd.) and allowed a crystallinity D resulting from a (022) plane to be 1000 Å in the case of using the expression (3) described above was used as K′.

### Oil Absorption Amount

The oil absorption amount (g/cm³) of each cathode active material obtained as described above for N-methyl-2-pyrrolidone (NMP) was determined according to a method defined in JIS K5101-13-1. Specifically, the oil absorption amount for NMP was determined by dropwise adding NMP while mixing the cathode active material, and measuring the amount of NMP required for slurrying.

### Carbon Content

The carbon content (% by mass) of each cathode active material obtained as described above was measured using a total organic carbon meter (TOC meter; ON-LINE TOC-VCSH, manufactured by SHIMADZU CORPORATION).

### Boron Content

The boron content (ppm) of the cathode active material obtained as described above was determined by inductively coupled plasma atomic emission spectroscopy (ICP-AES).

### Paste Viscosity

Into a 150-cc container, 6.00 g of the cathode active material which obtained as described above, and 5.56 g of carbon paste obtained by mixing a carbon conductivity additive material (Cabot Litx200) and polyvinylidene fluoride (PVDF, manufactured by KUREHA CORPORATION) at a mass ratio of 1:1 were added, and stiffened by MAZERUSTAR for 5 minutes. Then, 3.10 g of NMP was added, and the resultant was mixed by MAZERUSTAR for 10 minutes to prepare a paste for measurement having a solid content concentration of 45.5%. A half amount of the paste for measurement was put in the base of an E-type viscometer device (HAAKE Viscotester iQ), and the viscosity of the paste was measured at a temperature of 25° C. Two measurements were conducted, and the arithmetic mean value of the two measured values was regarded as the paste viscosity (mPa·s). Relative viscosities (%) based on the paste viscosity in Comparative Example 1 as a reference (100%) were also set forth in Table 1.

TABLE 1

| | Boron source | | | | | | | Specific | Crystal- | Oil | | | |
|---|---|---|---|---|---|---|---|---|---|---|---|---|---|
| | | Addition | | Granu- | Carbon | Boron | | surface | linity | absorption | Pellet | Paste | Relative |
| | | rate | Addition | lation | content | content | D₅₀ | area | D | amount | density | viscosity | viscosity |
| | Type | (mol %) | timing | step | (wt %) | (ppm) | (μm) | (m²/g) | (Å) | (g/100 g) | (g/cm³) | (mPa · s) | (%) |
| Example 1 | H₃BO₃ | 0.5 | Primary | Spray-dry | 1.3 | 320 | 9.4 | 19.7 | 685 | 29 | 2.07 | 1617 | 71 |
| | | | addition | | | | | | | | | | |
| Example 2 | H₃BO₃ | 1.0 | Primary | Spray-dry | 1.2 | 620 | 9.9 | 19.5 | 683 | 28 | 2.09 | 1581 | 69 |
| | | | addition | | | | | | | | | | |
| Example 3 | H₃BO₃ | 1.5 | Primary | Spray-dry | 1.2 | 930 | 10.0 | 19.6 | 664 | 28 | 2.05 | 1519 | 67 |
| | | | addition | | | | | | | | | | |
| Comparative | — | — | — | Spray-dry | 1.2 | — | 10.0 | 22.1 | 667 | 30 | 2.07 | 2281 | 100 |
| Example 1 | | | | | | | | | | | | | |
| Comparative | BPO₄ | 0.5 | Primary | Spray-dry | 1.2 | 320 | 9.7 | 13.5 | 698 | 33 | 2.03 | 2690 | 118 |
| Example 2 | | | addition | | | | | | | | | | |
| Comparative | BPO₄ | 1.0 | Primary | Spray-dry | 1.1 | 690 | 9.7 | 12.9 | 694 | 34 | 1.96 | 2553 | 112 |
| Example 3 | | | addition | | | | | | | | | | |
| Comparative | BPO₄ | 1.5 | Primary | Spray-dry | 1.1 | 1100 | 9.7 | 12.9 | 658 | 40 | 1.88 | 2639 | 116 |
| Example 4 | | | addition | | | | | | | | | | |
| Comparative | H₃BO₃ | 3.0 | Primary | Spray-dry | 1.2 | 1900 | 10.0 | 14.2 | 686 | 31 | 2.00 | 1823 | 80 |
| Example 5 | | | addition | | | | | | | | | | |
| Comparative | H₃BO₃ | 1.5 | Secndary | Spray-dry | 1.1 | 1200 | 9.4 | 12.7 | 686 | 30 | 2.10 | 2163 | 95 |
| Example 6 | | | addition | | | | | | | | | | |
| Comparative | — | — | — | — | 1.5 | — | 5.2 | 14.0 | 651 | 33 | 2.20 | — | — |
| Example 7 | | | | | | | | | | | | | |

Each of the specific surface area of the cathode active materials in Examples 1 to 3 in which orthoboric acid (H₃BO₃) was used as the boron source kept a high value of 19 m²/g or more. Each of the specific surface areas of the cathode active materials in Comparative Examples 2 to 4 in which boron phosphate (BPO₄) was used as a boron source stayed at a low value of around 13 m²/g. The specific surface areas of the cathode active material in Comparative Example 5 in which the amount of added orthoboric acid (H₃BO₃) was large and the cathode active material in Comparative Example 6 in which the secondary addition of orthoboric acid was performed also had low values. The specific surface area of the cathode active material in Comparative Example 7 in which no boron source was added and no granulation step was carried out also had a low value.

The paste viscosity of each of the cathode active materials in Examples 1 to 3 in which orthoboric acid (H₃BO₃) was used as a boron source was about 30% lower than that of the cathode active material in Comparative Example 1 in which no boron source was added. In contrast, the paste viscosity of each of the cathode active materials in Comparative Examples 2 to 4 in which boron phosphate (BPO₄) was used as a boron source tended to increase.

### Discharge Capacity

A battery for evaluation was produced in a manner described below with each cathode active material obtained as described above, and the discharge capacity of the battery was evaluated.

### Production of Cathode

In N-methyl-2-pyrrolidone (NMP), 87.5 parts by mass of the cathode active material, 2.5 parts by mass of acetylene black, and 10 parts by mass of polyvinylidene fluoride (PVDF) were dispersed to prepare cathode material mixture slurry. The obtained cathode material mixture slurry was applied to aluminum foil as a current collector, dried, then compression-molded by a roll pressing machine, and cut to have a predetermined size, whereby a cathode was produced.

### Production of Anode

In pure water, 97.5 parts by mass of artificial graphite, 1.5 parts by mass of carboxymethyl cellulose (CMC), and 1.0 part by mass of SBR (styrene-butadiene rubber) were dispersed and dissolved to prepare anode slurry. The obtained anode slurry was applied to a current collector including copper foil, dried, then compression-molded by a roll pressing machine, and cut to have a predetermined size, whereby an anode was produced.

### Assembly of Battery for Evaluation

A lead electrode was attached to each of the current collectors of the cathode and the anode, a separator was then disposed between the cathode and the anode, and they were housed in a sack-shaped laminate pack. Then, the pack was vacuum-dried at 65° C. to remove moisture adsorbed in each member. Then, an electrolytic solution was injected into the laminate pack under argon atmosphere, and the pack was sealed to produce the battery for evaluation. An electrolytic solution obtained by mixing ethylene carbonate (EC) and methyl ethyl carbonate (MEC) at a volume ratio of 3:7 and dissolving lithium hexafluorophosphate (LiPF₆) in the mixture to have a concentration of 1 mol/L was used as the electrolytic solution. The battery for evaluation obtained in such a manner was put in a constant-temperature bath at 25° C., and aged by a weak current, and the following evaluations of the battery were then performed.

### Discharge Capacity

The produced battery for evaluation was used, subjected to constant-voltage constant-current charge (cutoff current of 0.005 C) at a charging voltage of 3.65 V and a charging current of 0.2 C, and then subjected to constant-current discharge at a discharge final voltage of 2.0 V and a discharge current of 5 C. The discharge capacity (mAh/g) of the battery was measured, and a 5 C capacity density was calculated using a measured pellet density value.

### Charge and Discharge Capacity

The produced battery for evaluation was used, subjected to low-voltage constant-current charge (cutoff current of 0.2 mA) at a charging voltage of 3.65 V and a charging current of 0.2 C, and then subjected to discharge at a discharge final voltage of 2.0 V and a charging current of 0.2 C, and a 0.2 C charge capacity and a 0.2 C discharge capacity were measured. Then, the battery was further subjected to low-voltage constant-current charge (cutoff current of 0.2 mA) at a charging voltage of 3.65 V and a charging current of 0.2 C, and then subjected to constant-current discharge at a discharge final voltage of 2.0 V and a discharge current of 5 C, and a 5 C discharge capacity was measured. A rate characteristic was determined based on the rate of the 0.2 C discharge capacity to the 5 C discharge capacity. The results are set forth in Table 2.

TABLE 2

| | Charge | Discharge | Discharge | |
|---|---|---|---|---|
| | capacity | capacity | capacity | Rate |
| | 0.2 C | 0.2 C | 5 C | characteristics |
| | (mAh/g) | (mAh/g) | (mAh/g) | (%) |
| Example 1 | 162 | 160 | 140 | 87.1 |
| Example 2 | 163 | 161 | 140 | 86.9 |
| Example 3 | 162 | 160 | 139 | 86.9 |
| Comparative | 162 | 161 | 141 | 87.3 |
| Example 1 | | | | |
| Comparative | 161 | 159 | 136 | 85.6 |
| Example 2 | | | | |
| Comparative | 161 | 158 | 132 | 84.0 |
| Example 3 | | | | |
| Comparative | 160 | 157 | 132 | 83.9 |
| Example 4 | | | | |
| Comparative | 162 | 157 | 132 | 83.9 |
| Example 5 | | | | |
| Comparative | 163 | 159 | 135 | 85.0 |
| Example 6 | | | | |
| Comparative | 145 | 126 | 88 | 70.1 |
| Example 7 | | | | |

The cathode active materials in Examples 1 to 3 exhibited rate characteristics equivalent to the rate characteristic of the cathode active material in Comparative Example 1. However, the rate characteristics of the cathode active materials in Comparative Examples 2 to 7 were decreased. This is considered to be because the specific surface areas of the cathode active materials were reduced.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A method of producing a cathode active material for a secondary battery, the method comprising:
preparing a mixture comprising a lithium source, a phosphate source, an iron source, a carbon source, a boron source comprising an oxo acid of boron, and a liquid medium;
granulating the mixture to obtain a precursor; and
heat-treating the precursor to obtain a lithium transition metal compound having an olivine structure,
wherein in the mixture, a total molar amount of boron atoms contained in the boron source is more than 0% and less than 3% with respect to a total molar amount of iron atoms contained in the iron source as 100%.

2. The method of producing a cathode active material for a secondary battery according to claim 1, wherein the mixture is
prepared by performing pulverization treatment of a preliminary mixture comprising the lithium source, the phosphate source, the iron source, and the liquid medium, and then mixing the carbon source and the boron source,
prepared by performing pulverization treatment of a preliminary mixture comprising the lithium source, the phosphate source, the iron source, the carbon source, and the liquid medium, and then mixing the boron source,
prepared by performing pulverization treatment of a preliminary mixture comprising the lithium source, the phosphate source, the iron source, the boron source, and the liquid medium, and then mixing the carbon source, or
prepared by performing pulverization treatment of a preliminary mixture comprising the lithium source, the phosphate source, the iron source, the carbon source, the boron source, and the liquid medium.

3. The method of producing a cathode active material for a secondary battery according to claim 2, wherein the pulverization treatment is performed for 10 hours or more by using a ball mill.

4. The method of producing a cathode active material for a secondary battery according to claim 1, wherein a ratio of a mass of the carbon source in the mixture with respect to a total mass of iron atoms in the mixture is 15% or more and 30% or less.

5. The method of producing a cathode active material for a secondary battery according to claim 1, wherein the precursor has a volume mean particle diameter D₅₀ that is 1 μm or more and 20 μm or less.

6. The method of producing a cathode active material for a secondary battery according to claim 1, wherein the heat treatment is performed at 500° C. or more and 700° C. or less under a nitrogen atmosphere.

7. A cathode active material for a secondary battery, comprising a lithium transition metal compound having an olivine structure, having a boron content that is more than 0 ppm and less than 1900 ppm, and having a specific surface area that is 15 m²/g or more.

8. The cathode active material for a secondary battery according to claim 7, wherein an oil absorption amount of the cathode active material for N-methyl-2-pyrrolidone is 30 mL/100 g or less.

9. The cathode active material for a secondary battery according to claim 7, wherein a pellet density of the cathode active material is 2.00 g/cm³ or more in a case in which the cathode active material is compressed at a pressure of 3.5 MPa to form pellets.

10. The cathode active material for a secondary battery according to claim 7, wherein the lithium transition metal compound comprises a composition represented by the following formula:
Liₓ(Fe_{(1-y)}M¹_{y})_{(1-z)}M²_{z}(PO₄)_{w}
wherein x, y, z, and w satisfy 0.9<x<1.3, 0≤y<1, 0≤z<0.3, and 0.9≤w≤1.3, M¹ comprises at least one metal element selected from the group consisting of Mn, Co, and Ni, and M² comprises at least one metal element selected from the group consisting of Mo, Mg, Zr, Ti, Al, Ce, and Cr.
